(19) United States
(12) Patent Application Publication
(10) Pub. No.: US 2013/0233079 A1
(43) Pub. Date: Sep. 12, 2013

(54) SENSOR SYSTEM FOR DETECTING FLOW

(71) Applicants: THE UNIVERSITY OF MARYLAND, College Park, MD (US); MICHIGAN TECHNOLOGICAL UNIVERSITY, Houghton, MI (US)

(72) Inventors: Raymond Andrew Swartz, Houghton, MI (US); Alison Behre Flatau, Potomac, MD (US)

(73) Assignees: MICHIGAN TECHNOLOGICAL UNIVERSITY, Houghton, MI (US); THE UNIVERSITY OF MARYLAND, College Park, MD (US)

(21) Appl. No.: 13/796,351

(22) Filed: Mar. 12, 2013

Related U.S. Application Data
(60) Provisional application No. 61/609,618, filed on Mar. 12, 2012.

(51) Int. Cl. G01F 1/56

(52) U.S. Cl. CPC G01F 1/56
USPC 73/579; 73/861.08

(57) ABSTRACT

This invention relates to flow sensors, systems, and methods useful for detecting and/or monitoring flow of a fluid. The invention is also related to detecting and/or monitoring the presence of scour, overtopping, and/or bed migration.

### CROSS REFERENCE TO RELATED PATENT APPLICATION

This application claims the benefit of U.S. Provisional Patent Application Ser. No. 61/609,618, filed Mar. 12, 2012, which is hereby incorporated by reference in its entirety.

This invention was made under government sponsorship: ONR N000140610530 awarded by the Office of Naval Research (ONR). The government may have certain rights in the invention.

### FIELD OF THE INVENTION

This invention relates to sensors, systems, and methods useful for detecting and/or monitoring flow of a fluid.

### BACKGROUND OF THE INVENTION

Scour is a severe problem that results in millions of dollars of damage to infrastructure and substantial loss of life annually. Scour occurs during times of high tides, hurricanes, rapid river flow, and icing conditions, when sediment, including rocks, gravel, sand, and silt, are transported by currents, undermining bridge and pier foundations, submarine utility cables, and pipelines, and filling in navigational channels. Scour is dynamic; ablation and deposition can occur during the same high energy hydrodynamic event. The net effect of scour has not heretofore been easily predicted, nor readily monitored, in real time.

Bridge scour is the leading cause of failure for bridges over water in the US and abroad. Currently, bridge piers and abutments are either unprotected or protected by riprap, a scour countermeasure that is subject to edge failure and unpredictable settlement. Sufficient manpower is often not available to inspect all bridges in a geographical location more than once every one or two years. This reality is especially troubling considering that, while sediment does scour during large storm events, the extent to which scour holes infill during the receding limb of the storm hydrograph is often unknown. In such cases, a manual inspection occurring after the storm will yield a negative assessment of scour danger, even if the scour depth was dangerously close to the bottom of the bridge foundation at some point in time.

Embedded instrumentation approaches have been developed for scour monitoring, but suffer from drawbacks that negatively affect their suitability for low-cost, autonomous operation. For example, sonic depth sounders experience difficulty in turbulent waters, those with high levels of suspended sediments, or icy waters. Sliding collar devices do not depend on water quality, but only provide an indication of lowest scour level. Subsurface, geophysical methods (e.g., continuous seismic-reflection profiling and ground penetrating radar) may detect real-time scour information, but require extensive time, knowledge, and training to interpret. Buried RF-based scour sensors (buried devices that transmit alerts when their cover erodes away) can indicate scour when it reaches a critical level but, like the sliding collar devices, are one shot devices; also, there is no way to distinguish between safe conditions (no scour) and failure of the buried electronic device.

In addition to scour concerns, it is often not known during storms how close the water level comes to the bridge deck or if overtopping occurs, a situation that could lead to bridge overturning. Furthermore, since scour and overtopping are both correlated with high-flow events, their combined effect can lead to increased likelihoods of bridge failure. Existing scour detection methods do not detect overtopping despite the potential link. There is a dire need for a sensing approach that can record instantaneous information on both water and sediment levels during storms and thereby enables immediate action such as automatic bridge closure or notification of bridge officials.

The present invention is directed to overcoming these and other deficiencies in the art.

### SUMMARY OF THE INVENTION

A first aspect of the present invention is related to a sensor including at least one magnetostrictive sensing element.

Other kinds of flow sensors could be used in the various aspects described in the present invention. These flow sensors can detect and/or monitor flow of a fluid. These include a variety of flow sensors known in the art such as differential pressure flow sensors, velocity flow sensors, positive displacement flow sensors, mass flow sensors, open channel flow sensors and the like. The sensors also include sensors which can detect flow based on effects such as piezoelectric effect, electromechanical effect, magnetomechanical effect or the like.

In a second aspect, the invention is related to a system for detecting and/or monitoring scour, bed migration, or overtopping associated with an interface between a fluid and bed of material including at least one first flow sensor, according to the invention, disposed at or near the interface such that the sensor is capable of detecting and/or monitoring scour, bed migration, or overtopping.

In a third aspect the present invention is related to a method of detecting and/or monitoring scour, bed migration, or overtopping associated with an interface between a fluid and a bed of material including deploying at least one first flow sensor according to present invention at or near the interface; and detecting and/or monitoring measurements from the flow sensor.

In a fourth aspect the present invention is related to using the sensors of the present invention for detection of other physical phenomena, including force, acoustic pressure, tactile/haptic/navigation applications, applications where biological systems employ whisker sensors, active whiskers, for instance to create turbulence in flows to improve ability of these or other sensors to detect low concentrations of chemical or biological species, or low flow rates, detection of vibrations.

Certain embodiments of the sensors of the present invention can be mass produced and can have a tremendous impact on the state of health of various bridges and piers. Mass production and cost efficiency paves the way for rapid distribution to highway agencies and ensures public safety. Furthermore, it assists the highway officials for scheduling periodical maintenance programs and circumvents costly repairs and bridge replacements as well as emergency road closures. These and other advantages of certain embodiments of the present invention, as well as additional inventive features, will be apparent from the description of the invention provided herein. Certain embodiments of the sensors of the present invention are capable of monitoring scour depth. Embodiments of the flow sensors of the present invention include a single sensor or an array of sensors.

### BRIEF DESCRIPTION OF THE DRAWINGS

FIG. 1 shows an embodiment of a flow sensor of the present invention.

FIGS. 2A-B show another embodiment of a flow sensor of the present invention. FIG. 2A shows a side view of the flow sensor that can be installed on a structure. FIG. 2B shows a cross-section along A-A of the flow sensor shown in FIG. 2A.

FIG. 3 shows an embodiment of the present invention in the form of a sensor post which includes the magnetostrictive flow sensors of the present invention. This structure can be embedded wholly or partially into a bed at or near a fluid and a bed interface.

FIG. 4 shows an exemplary arrangement of the flow sensors of the present invention, wherein the sensors are deployed on a column which is partially submerged in water and has a portion that is embedded in the sediment layer at the bottom. Such an arrangement can be used for monitoring events related to erosion due to fluid flow such as scour, river bed migration.

FIG. 5 shows another exemplary arrangement of the flow sensors of the present invention, wherein the sensors are deployed on a column supporting a bridge.

FIG. 6 shows an arrangement which is useful for testing various embodiments of the present invention.

FIGS. 7A-B show an exemplary system which can be used for monitoring scour or river bed migration. FIG. 7A shows a front view of a system which can be used at a pier for monitoring scour at leading and trailing edges of a flowing water body. FIG. 7B shows a side view of the system.

FIGS. 8A-B show an exemplary arrangement of the present invention which can be used for monitoring scour or bed migration at a river bank. FIG. 8A shows a view from the top. FIG. 8B shows a view from the side along section A-A.

FIGS. 9A-B show an exemplary arrangement of the present invention which can be used for monitoring scour or bed migration at a culvert. FIG. 9A shows a view from the front. FIG. 9B shows a view from the side.

FIG. 10 shows an exemplary arrangement of the present invention which can be used to wirelessly monitor a river bank for bed migration or scour using sensor posts of the present invention.

FIG. 11 shows an exemplary arrangement of the present invention which can be used to monitor and/or detect overtopping of a structure such as a bridge.

### DETAILED DESCRIPTION OF THE INVENTION

A first aspect of the present invention is related to a sensor including at least one magnetostrictive sensing element. In one embodiment the sensor includes a magnetostrictive sensing element having at least one free floating distal end. The sensor can be designed such that it is capable of sensing, for example, fluid flow, force, displacement, vibration, frequency of vibrations, fluid flow rates. The magnetostrictive sensing elements can be designed such that they can deform in a flowing fluid or exhibit strain upon contacting a flowing fluid.

Other kinds of flow sensors could be used in the various aspects described in the present invention. These flow sensors can detect and/or monitor flow of a fluid. These include a variety of flow sensors known in the art such as differential pressure flow sensors, velocity flow sensors, positive displacement flow sensors, mass flow sensors, open channel flow sensors and the like. The sensors also include sensors which can detect flow based on effects such as piezoelectric effect, electromechanical effect, magnetomechanical effect or the like. In a preferred embodiment the sensor includes a magnetostrictive sensing element.

In one embodiment the sensor includes a reader coupled to the magnetostrictive sensing element such that the reader can operably detect and/or monitor deformation or stress associated with a magnetostrictive sensing element. The magnetostrictive sensing element of the sensor is also capable of reversibly deforming in a flowing fluid. The deformation could be caused due the drag associated with, e.g., a flowing fluid.

An exemplary sensor of the present invention includes a magnetostrictive sensor designed and constructed to detect fluid flow. Vibrissa-like flow elements (whiskers) can be cut from sheets of the magnetostrictive iron-gallium alloy, Galfenol. These elements can be cantilevered, with the fixed end (proximate end) of the element attached to a permanent magnet to provide the flow element with a magnetic bias. The free portion (distal portion) of the flow element can be quasi-statically loaded, causing the flow element to bend when it encounters a flowing fluid. The bending-induced strain causes magnetization of the flow element to change, resulting in a changing magnetic field in the area surrounding the flow element. The change in magnetic field can be detected, for example, by a giant magnetoresistance (GMR) sensor placed in proximity to the flow element. In some embodiments, the electrical resistance change of the GMR sensor is a function of the bending in the flow element due to flowing fluid.

The magnetostrictive sensing elements described in the present invention are based on the principle of magnetostriction. Magnetostriction refers to a material property by which there exists a significant coupling between mechanical strain and the state of magnetization within a material. Such unique couplings are highly beneficial in the development of novel sensors. Magnetostrictive materials strain in response to an external magnetic field or change in magnetization in response to mechanical forces.

Magnetostrictive materials demonstrate magnetostriction—a change in dimensions—upon application of a magnetic field, or change magnetization upon application of a mechanical force. (Lee, E., Magnetostriction and Magnetomechanical Effects, Rep. Prog. Phys. (1955), which is hereby incorporated by reference in its entirety). Terfenol-D—an alloy of terbium, dysprosium, and iron—demonstrates very large magnetostrictive strains. Galfenol is an iron-based alloy containing gallium and can also show magnetostrictive strains. Galfenol is more ductile and has a tensile strength up to 20 times that of Terfenol-D.

Magnetostrictive materials are made up of magnetic domains—regions of uniform magnetization. When the material is in an unmagnetized state, the domains are distributed in different directions to minimize the internal energy. As a magnetic field is applied to the material, the minimum internal energy happens when the domain moments are aligned with the direction of the field. Overall, this results in the material changing in length in the direction of the magnetic field. This phenomenon, the Joule effect, is the mechanism by which magnetostrictive actuators function.

The inverse of the Joule effect is the Villari effect. If magnetic domains of the material are already aligned with the direction of the magnetic field, then a compressive force along the same axis of the field—will cause the domains to rotate to a direction perpendicular to the field. The Villari effect allows for magnetostrictive-based sensors that can measure force and displacement.

The magnetostrictive sensing element of the sensors of the present invention could have a cross-section which is in the shape of, for example, a circle, a square, a rectangle or oblong. The sensors of the present invention could be designed to measure, for example, force, strain, displacement, vibration, frequency of vibrations, flow rates and the like.

The sensitivity of the magnetostrictive sensing elements may be adjusted by altering its dimensions. The magnetostrictive sensing elements could also be “flagged.” By flagging it is meant that the magnetostrictive sensing element has a passive material bonded/glue/welded to one end of the whisker in order to increase drag and create greater deformation or strain in the element for a given velocity of flow. In one embodiment the magnetostrictive sensing elements of the present invention can measure flow velocities that range from 0 to 20 feet per second.

The sensors of the present invention have many advantages. They can be designed to be always active. They are capable of providing continuous measurements in real time or continuously record the measurements. The sensors could also be designed such that they are capable of issuing event warnings or alerts. Furthermore, these sensors are inexpensive, because they require low power and are low maintenance, they are easy to install, and can be manufactured inexpensively.

The sensors and systems described in the present invention are independent of fluid quality, and capable of detecting scour, river bed migration, overtopping and other erosion events related to a fluid and bed interface. Additionally, they are robust, that is difficult to damage, and are capable of working in a variety of fluid conditions such as turbulent waters, waters where sediments are suspended, waters with lot of debris or ice. Further more the sensors are capable of remaining buried or in contact with the sediment or bed materials for prolonged time periods. The sensors may include a housing that is adapted such that the sensor can be introduced into a fluid without damage.

The sensors of the present invention may also be adapted to be introduced into a fluid. They could also be adapted to be introduced in a bed of material, on a bed of material or under a bed of material. The magnetostrictive sensing element could be deployed at different angles with respect to the fluid flow or the surface of the bed. For example, they could be titled such that they are at a right angle to the flow of the fluid or parallel to the flow of the fluid. Similarly, they could be placed in the bed of material at any angle, for example, they could be at a right angle to the surface of the bed or parallel to the surface of the bed.

These sensors may be adapted such that they can be deployed in a fluid or a bed material for long durations of time. In a preferred embodiment the sensors of the present invention can be designed such that they can provide measurements for hundreds of years. Various methods known in the art could be used to make the sensors more robust, for example, by applying a coating on the sensor or the magnetostrictive element. The sensors could also be designed to derive power from a battery pack. The battery pack could be rechargeable. Various energy sources such as geothermal power, solar power and the like can be used to recharge the battery packs.

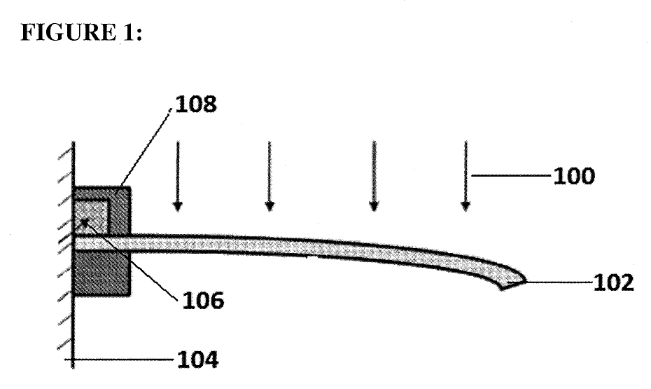

The sensors of the present invention may include a magnetostrictive flow element that is in the shape of a cantilever arm. FIG. 1 shows a schematic representation of the magnetostrictive sensor of the present invention. Flow of fluid 100 can be detected using the sensor. The sensor includes a magnetostrictive sensing element 102 which is, for example, cantilevered and attached to a base 108. The sensor also includes a reader 106 which is, for example, fixed in base 108 and is capable of detecting magnetic field changes resulting from, for example, bending of element 102. The base 108 can be further fixed to a substrate 104 wherein the substrate could be a column which is a part of a bridge or an independent post which can be, for example, embedded into a river bed. The element 102 could be bent by various external stimuli such as drag forces due to fluid flow.

The magnetostrictive sensing element may be made of magnetostrictive materials such as Galfenol, Terfenol-D, Alfenol, Metglas, iron, nickel, cobalt, iron aluminium alloy, iron cobalt, or a combination thereof. Various other kinds of magnetostrictive alloys could also be used for the purposes of the present invention. In a preferred embodiment the flow element is made of Galfenol.

Single crystal Fe—Ga alloys or Galfenol with large magnetostriction values of up to 400 ppm were introduced in the early 2000s. They are a structural material that exhibits robust mechanical properties and magnetostriction that is useful for sonar, sensing, and energy harvesting applications. The development of inexpensive, macroscale Galfenol samples enable the construction of unique flow sensors based on the magnetostrictive property of Galfenol. Galfenol whiskers that can be easily bent by fluid flow will exhibit changes in their magnetic field. These changes can be measured, for example, by using the robust and inexpensive magnetic field sensors found on read/write heads in conventional computer hard drives. Where the drag forces on the whiskers are well understood, these magnetic changes are easily correlated to fluid flow rates. A rolling mill and furnace can be used to produce Galfenol strips of varied widths and lengths. The process can be scaled up to make Galfenol strips that are of up to tens of meters in length with width and thickness appropriate for construction of flow sensors of desired lengths and sensitivities.

The sensors of the present invention can be designed such that they are capable of exhibiting a mechanical deformation which is dependent upon the flow of the fluid. It is preferable to have a relationship between the degree of deformation and the flow of the fluid.

The sensors could be adapted by applying a coating on the whole surface of the sensor or the magnetostrictive sensing element such that the sensor can operate inside the fluid for a desired period of time. In a preferred embodiment, the sensors can operate inside a fluid for hundreds years. The magnetostrictive sensing element of the present invention may be covered with a coating depending upon the site of deployment. The sensors of the present invention can operate in, for example, brackish, saline or fresh water. River water tends to be quite variable and may contain dissolved salts, gases, or pollutants that may be either beneficial or harmful to the magnetostrictive materials, e.g., Galfenol, which, as a ferrous alloy, has corrosion properties that are similar to steel. The corrosion of Galfenol in waters depends upon the type of water, although pH has little effect over the range of natural waters (i.e., pH 4 to pH 9) and corrosion losses from water immersion generally are lower than for seawater. Appropriate methods of protecting Galfenol strips from corrosion may be employed to increase their effective lifespans.

Cathodic protection, epoxy coating, plastic coating, galvanizing, and/or chromium electroplating can be used to protect the sensors of the present invention. Cathodic protection can be effectively applied to immersed structures such as bridge piers. Aluminum or zinc alloy pieces are employed as sacrificial anodes to impart immunity from corrosion for the Galfenol strip. The effective lifespan can be increased by the use of an additional epoxy coating covering the exposed surface of the Galfenol strips. In the case of a sensor strip or array buried in a riverbed composed of soil, sand, and gravel, abrasion resistance is necessary as well. An electroplated chromium thin-film coating can be applied between the Galfenol strip and the external epoxy layer to ensure protection and abrasion resistance. Corrosion protection layers, which act as a hard coating, must be exactly characterized as applied to properly estimate the bending caused by water flow.

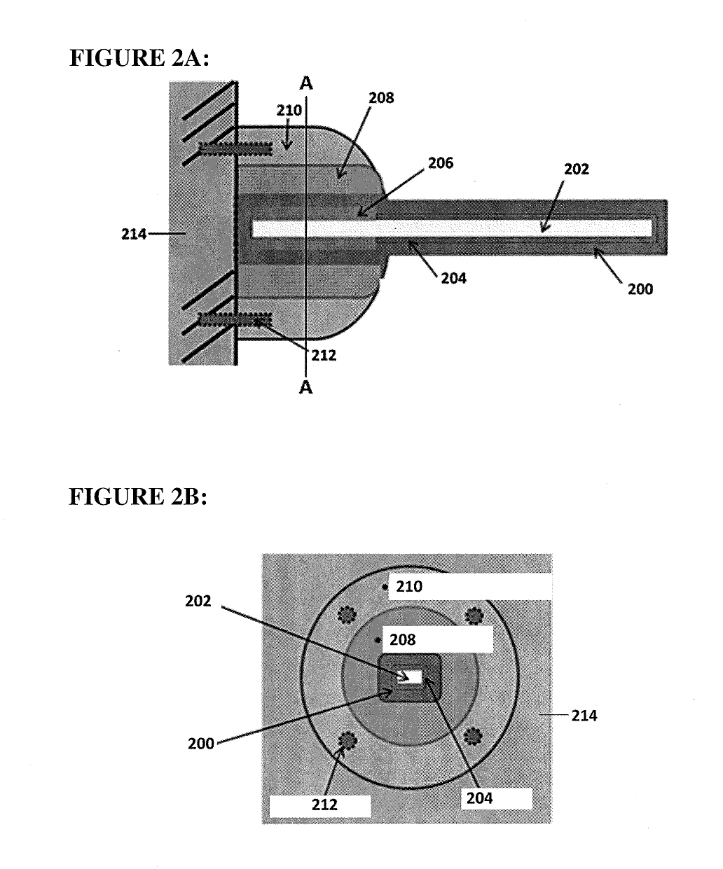

FIG. 2 shows a schematic diagram of corrosion-protective coating layers for a sensor of the present invention. FIG. 2A shows a Galfenol strip 202, that is approximately 0.5 to 1 mm in thickness, and is coated with an epoxy coating 200 that is approximately 0.1 to 0.3 mm in thickness. Optionally, a chromium film that is 1-2 microns thick is also applied to Galfenol strip 202. Galfenol strip 202 is coated at its distal end with an Al anode which is approximately 0.2 to 0.5 mm thick. The whole magnetostrictive sensing element comprising the Galfenol strip 202 and the various optional coatings is attached to a confinement mold 210 using epoxy filing 208. Confinement mold 210 is further attached to a supporting structure 214, such as a bridge column or pier surface, using anchors 212. FIG. 2B shows a cross-section of FIG. 2A along AA. The sensor, as shown in FIG. 2, can be attached, for example, on a pier surface as a modular structure using anchors 212 or epoxy or the like.

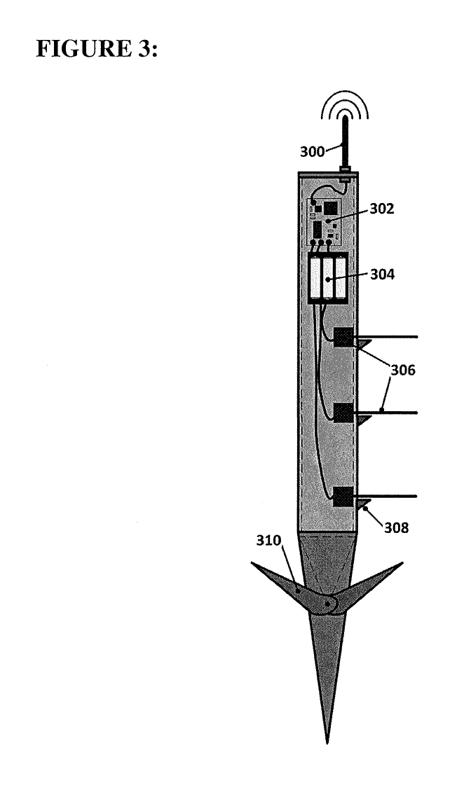

FIG. 3 shows a modular sensor post which can be used, for example, for scour detection. It contains at least one flow sensor 306 mounted on the outer surface of the sensor post. It could be embedded or driven into the sediment around an area which is at risk of scour or overtopping or river bed migration. It may include a battery pack which is designed to provide power to the sensor post or could be attached to a solar panel depending upon the location. It also consists of an onboard electronics board 302 which is capable of interrogating raw data originating from sensor 306. Sensor 306 could be placed such that corbel 308 protects the flow sensor during the installation of the post in the sediment layer. A wireless transmitter 300 is connected to board 302 such that transmitter 300 could transmit results, processed or unprocessed, to a base station capable of interpreting the data. The base station is capable of aggregating data from multiple sensors or sensor posts. The base station could be designed such that it contains cellular data links and solar power cells to recharge the batteries. Transmitter 300 could have an external transmitter or an internal transmitter. The post also includes hook 310 which prevents the post from toppling or pull-out.

The sensors of the present invention may be embedded inside or mounted to the surface of a post which will then be embedded into, for example, a river bed. As scour initiates and develops, the sensor elements may deform or exhibit strain due to flow of the fluid. The deformation or strain of the element due to flow of the fluid is accompanied by a proportionate change in its magnetostrictive properties. Multiple sensors can be used, for example, in development of robust scour sensor arrays to detect riverbed levels at bridge foundations or at any other fluid and bed interface. This provides for redundancy in the measurements and can provide detailed information about the extent scour. Also, multiple sensors could be used to detect the range of flow velocities associated with the fluid. Multiple sensors which are capable of measuring different rates of flow can also be used to obtain detailed information about the flow rates. For example a sensor which detects a flow of 0.1 feet per second could be deployed with a sensor which can detect a flow of 20 feet per second.

The sensors of present invention may include a transmission module for transmitting measurements from the sensor. The transmission module could be a part of the sensor or could be a separate module that is incorporated into, for example, a post as shown in FIG. 3. Furthermore, the sensors of the present invention could have a receiver module capable of receiving signals from, for example, a base station. The receiver module could be a part of the sensor itself or could be a separate module that is incorporated into a sensor array or a sensor post. The signal, for example, could be a wireless signal.

One of the tasks to be performed by the sensors of the present invention is flow detection. The system described in the present invention operates by differentiating between static and dynamic flow measurements returned from the magnetostrictive sensing elements. The static flow measurement can, for example, be obtained from sensors buried inside the sediment. The dynamic flow measurements are, for example, obtained from sensors exposed to a flowing fluid. For fast moving and turbulent water bodies, such a distinction is relatively trivial to make from highly varying sensor data. For slow moving bodies exhibiting laminar flow around piers, application of sophisticated autonomous signal processing techniques can help to distinguish genuine perturbations from noise. An computer could, for example, be used to analyze the measurements from the sensors. Interpretation of the measurements from the sensors could be done using an algorithm.

The present invention also envisions a sensor fault detection system in order to reduce false alarms due to sensor failure. Significant progress has been made in the field of fault detection for permanently installed sensor arrays. The issue of sensor failure is sometimes troublesome in scour monitoring systems in which static, or noise only, sensor signals are used as an important indicator (in this case, presence of sediment). Without embedded sensor fault detection algorithms, signals measured from damaged sensors may be easily interpreted as dynamic data potentially triggering false alarms, or worse, as static data, potentially missing hazardous scour events.

In one embodiment, the present invention provides a sensor capable of detecting and monitoring scour in, for example, ridge, water channel, a river bank, a river bed, a pier, culvert, bridges such as railway bridges, and flood prone areas. In another embodiment, the present invention provides a sensor for detection and monitoring of overtopping, for example, overtopping of bridges. In yet another embodiment, the present invention provides a sensor for detection and monitoring of bed migration for water bodies such as rivers.

In a second aspect, the invention is related to a system for detecting and/or monitoring scour, bed migration, or overtopping associated with an interface between a fluid and bed of material including at least one first flow sensor, according to the invention, disposed at or near the interface such that the sensor is capable of detecting and/or monitoring scour, bed migration, or overtopping.

The system according to the second aspect could use a variety of flow sensors known in the art. These flow sensors can detect or monitor flow of a fluid. These include flow sensors such as differential pressure flow sensors, velocity flow sensors, positive displacement flow sensors, mass flow sensors, open channel flow sensors and the like. The sensors also include sensors which can detect flow based on effects such as piezoelectric effect, electromechanical effect, magnetomechanical effect or the like. In a preferred embodiment the flow sensors comprise at least one magnetostrictive sensing element.

The systems of the present invention also include a structure. The structure could be such that a part of the structure is capable of contacting a bed of material. The structure could be, for example, a part of a bridge, a river bank, a river bed, a pier, a culvert, or a sensor post as described in FIG. 3. The post could be configured such that it can be partially or fully embedded in the bed of material.

In an exemplary system, a first set of flow sensors could be deployed such that some of them are exposed to the fluid or capable of contacting a fluid. Some of the sensors may be deployed such that they are embedded in the bed material or are in contact with the bed materials. In the event of scour, the sensors embedded in the material will be exposed to the fluid and provide information about the scour such as the extent, the depth of scour, and the rate at which scour is progressing.

In one embodiment, the system also includes at least one second flow sensor disposed on a part of a structure such that the sensor is capable of contacting the bed. These sensors could provide data which can be used as a reference providing static measurements. Upon exposure to the fluid, in cases where scour occurs or due to erosion, the second set is also capable of detecting and/or monitoring scour, river bed migration. In the event of scour, the second set of sensors would be exposed to the fluid and provide information about the scour event, extent, depth, and rate of scouring or risk associated with scour.

The sensor systems can be installed in foundation for new bridge construction where sensors may be readily installed on all sides of the bridge foundation (including underneath) and their cables routed inside of the foundation to the base station. Installation for existing bridges is more difficult; however, a jet of pressurized water may be used to create a small hole in any sediment that possesses a minimum level of stability, allowing temporary access to place sensors and cables below the sediment line. Similarly, sensor posts as described in FIG. 3 could be placed at or near the interface of fluid-material in order to detect or monitor scour. Sensor post of the present invention could be deployed using a hollow stem auger.

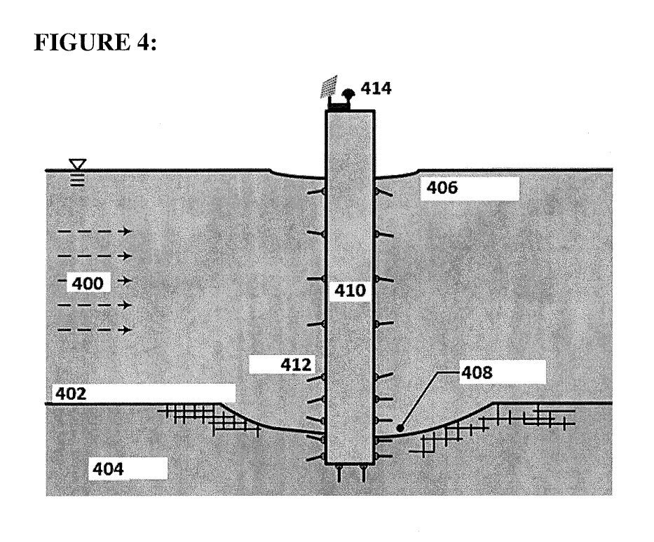

FIG. 4 shows an arrangement which can be used for detecting and/or monitoring scour near an interface 402 between a flowing fluid 400 and sediment 404. Sensors 412 are mounted on a pier 410 which is capable of extending into a bed of sediment or material 404. Some sensors 412, above sediment level 402 and below fluid level 406, are exposed to fluid 400. Other set of sensors may be embedded into sediment 404 below sediment level 402. A scouring event can remove sediment near the base of pier 410 as shown by 408 and expose a group of sensors, originally below sediment level 402, to the fluid. These newly exposed sensors would produce a measurement which can be detected and monitored. The signals from the newly exposed sensors could also be compared to the signals from sensors already exposed to fluid in order to compare flow rates or the degree of scour. Historical data from the newly exposed sensors and the sensors exposed to the fluid could also be compared to gain further insights into the scouring event. The measurements from sensors 412 could be transmitted to a base station 414 for analysis, interpretation, or for further transmission.

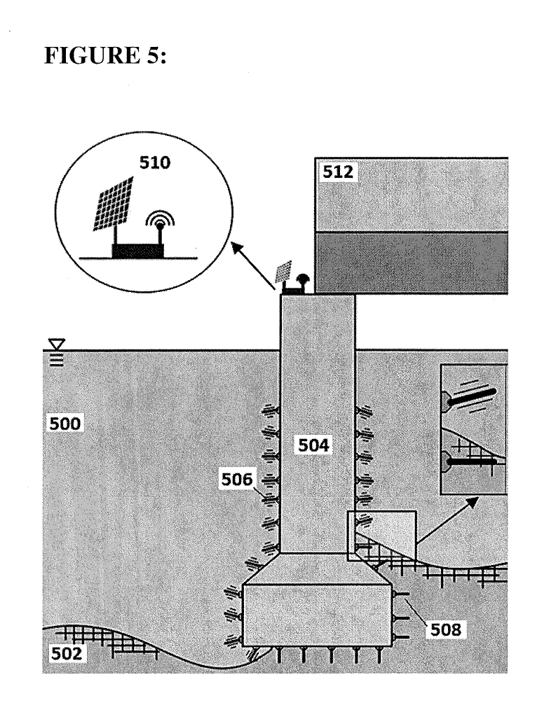

FIG. 5 shows an arrangement which can be used for detecting and/or monitoring scour near the base of a bridge 512 having a column 504. Column 504 is positioned such that a portion of column 504 is exposed to fluid 500 and a portion of column 504 in embedded in sediment 502. One set of sensors could be placed on column 504 such that some sensors 506 are below the fluid level and above the sediment level. Sensors 506 are capable of providing dynamic readings on the fluid flow. Another set of sensors 508 could be placed such that they are below the level of sediment and provide static readings. The inset shows a first sensor 506 capable of providing dynamic readings and a second sensor 508 capable of providing static readings. The readings from sensors 506 and 508 could be transmitted to a base station 510 for analysis or for further transmission. The base station 510 can be designed such that it is capable of aggregating, analyzing, and interpreting data from multiple sensors. Dynamic readings and static readings from the sensors can be utilized to provide an estimation of the river depth based on the location of the sensor, for example depth. This arrangement could be used to detect pier undermining, channel aggradation, abutment erosion or outflanking. The data generated from the sensors could be used for forecasting scour. The base station could be designed such that it issues warning or alerts to the authorities about dangerous conditions via the cellular data network. In one embodiment the system could be designed such that it is capable of automatically closing gates to a bridge and stop traffic in case of a dangerous situation.

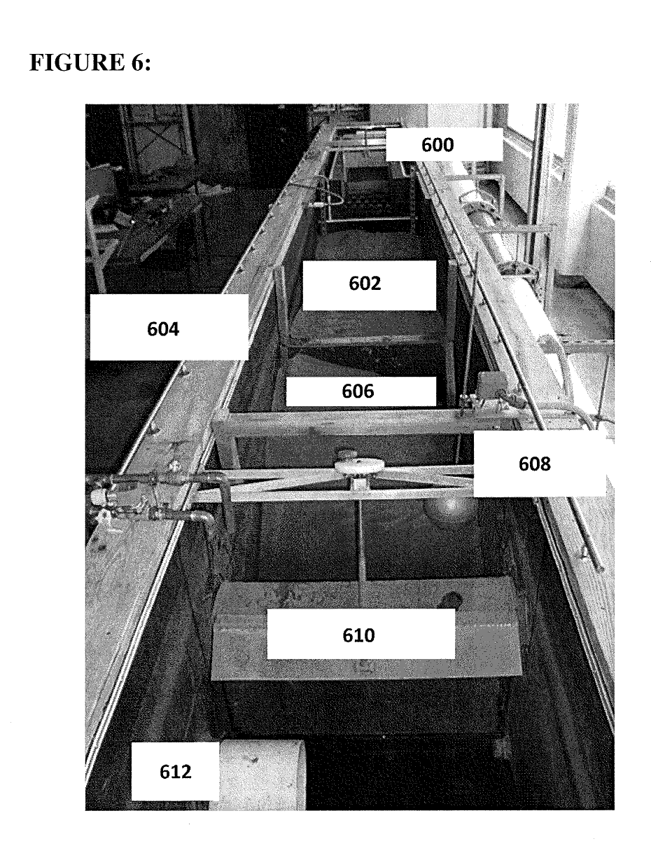

FIG. 6 shows a setup which may be used for testing the sensors of the present invention. It includes a water inlet 600 which allows water to flow through at a certain rate. A scour testing zone 602 is used to study the mechanism and the operation of various embodiments of the sensor systems of the present invention. The sediment from the flow is trapped in a sediment trap 606 and a float valve 608 controls the depth of the water inside testing zone 602. An adjustable tail gate 610 is used for controlling the level of water and for flow control. A water outlet 612 allows for water to go out of the testing channel. The instruments for measurement and testing could be mounted on a mounting rail 604.

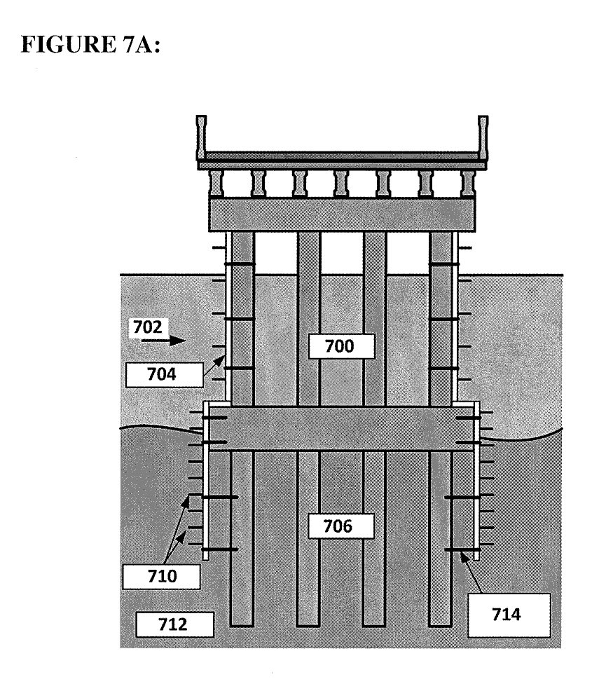

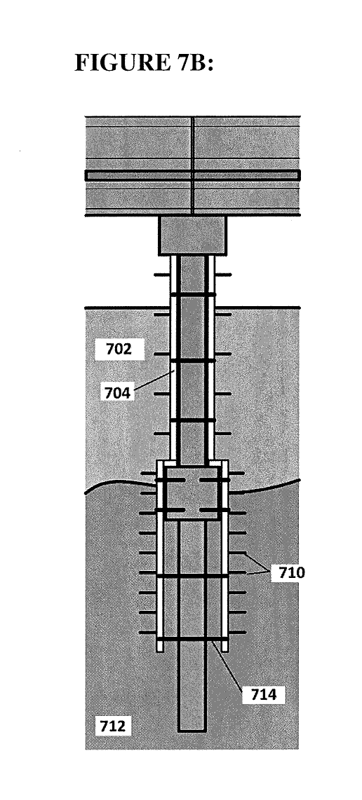

FIG. 7A shows an example of how the sensors of the present invention could be mounted on a pier 700 having piles 706. Sensors 710 could be mounted on a conduit 704 such that some sensors are above the water level; some sensors are below the water level but above sediment 712 level. Some sensors could be placed such that they are embedded in sediment 712. Anchors 714 could be used to deploy the sensors on piles 706. 702 indicates flow of water. This arrangement could be used for monitoring scour at the leading and the trailing edge of the pier. FIG. 7B shows a side view of the system shown in FIG. 7A.

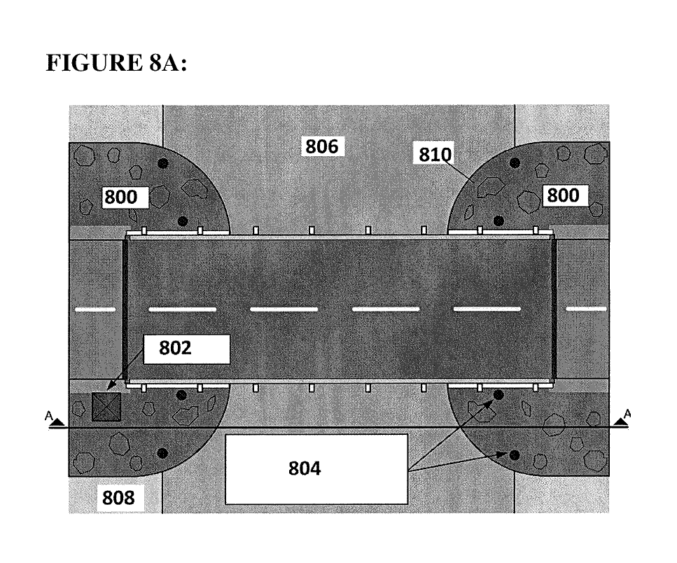

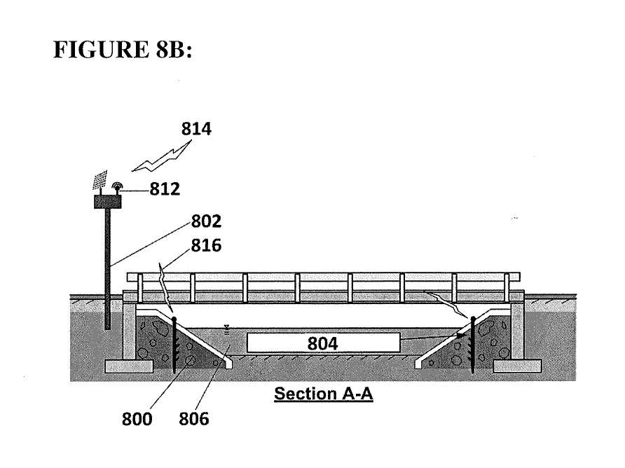

FIG. 8A shows a top view of a system which can be used for detecting or monitoring scour and/or river bed migration at a river bank. Scour at a river 806 with riprap 800 can be monitored using sensor posts 804 which are embedded at places 810 and 808 which may be at risk of scour or river bed migration. The posts are embedded in the sediment at scour or bed migration prone regions 808 and/or 810. These posts can be embedded partially or fully into the sediment. In the event river bed migration or scour occurs, posts 804 will be exposed to fluid and will relay the flow data wirelessly to a base station 802 thereby indicating scour or river bed migration. The base station 802 may relay the data to a centralized location for further data analysis. FIG. 8B is a side view of FIG. 8A. Sensor posts 804 send or receive a wireless signal 816 to/from base station 802 having a wireless antenna 812 which further transmits the signal to authorities or to another location for analysis. The wireless signal from sensor post 804 could be a low-power Zigbee link and the signal from base station 802 could be a high-power cellular link.

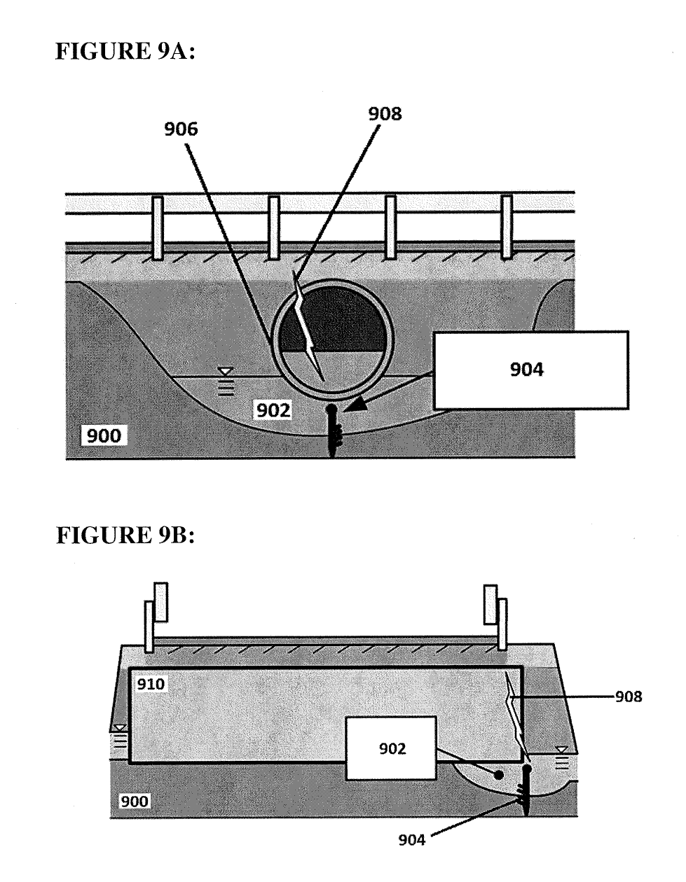

FIG. 9 shows an arrangement for detecting and monitoring scour or bed migration at a culvert. FIG. 9A shows a culvert with an opening 906 and a scour hole 902 which is being monitored by a sensor post 904 buried in sediment 900 near the opening of culvert 906. Sensor post 904 could be embedded such that some sensors are in contact with water and some sensors are in contact with the sediment bed. However, in an embodiment it is also possible to have a system where all the sensors of sensor post 904 are embedded in sediment layer 900. Sensor post 904 can send and receive wireless signals 908 to and from a base station as described supra. FIG. 9B shows a side view of the system shown in FIG. 9A. The culvert is shown as 910. The scour hole is 902.

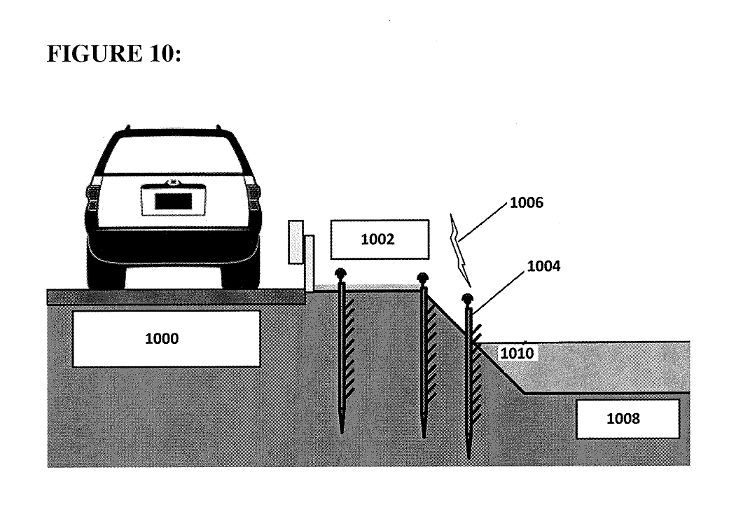

FIG. 10 shows a river bank which could be monitored for erosion. Bank 1000 is adjacent to a river 1010 with a bed 1008. Bank 1000 and bank top 1002 could be monitored for erosion, overtopping, or scour formation using sensor post 1004 which is capable of sending and receiving wireless signals 1006 to and from a base station as described supra. Sensor posts 1004 are embedded in the bank sediment and could be used to detect erosion. In one embodiment sensor post 1004 could be buried all the way into the bank. In another embodiment the sensor post 1004 could be buried such that a part of the sensor post is exposed to the river and a part of the sensor post is buried in the bank.

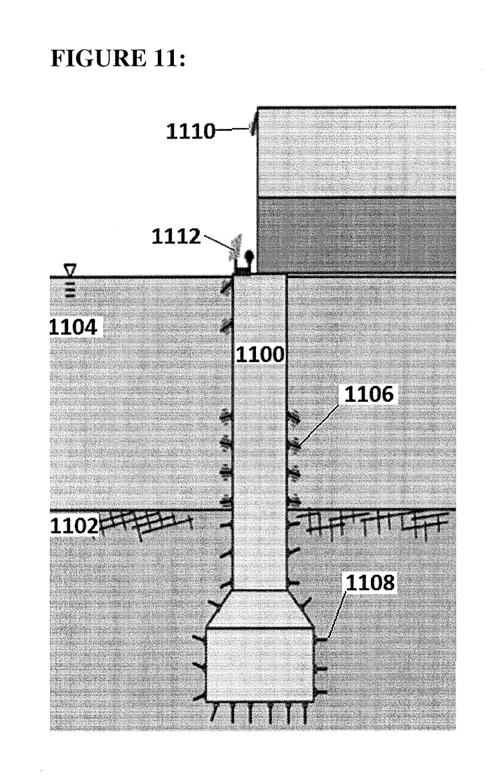

In another embodiment, the system according to the present invention also includes at least one third flow sensor disposed on an object at or near the fluid and bed interface wherein the object is at risk of being overtopped with the fluid. This third flow sensor could include a magnetostrictive sensing element. FIG. 11 shows an exemplary system or arrangement which can be used for detecting and/or monitoring overtopping of a structure such as a bridge 1100. The column of bridge 1100 is submerged partially in a fluid 1104 and is partially embedded in sediment 1102. Sensors such as 1106 may be deployed such that they are exposed to fluid 1104. Other sensors such as 1108 may be deployed such that they are embedded in the sediment. Furthermore, a set of sensors such as shown by 1110 may be deployed at objects which are at risk of overtopping. Note that sensor 1110 is deployed above the fluid level. The signals from the sensors could be sent to a base station 1112 for further analysis and transmission. The signals from sensor 1106 could be compared to signal from 1110 in order to detect overtopping. In the event of overtopping, sensor 1110 will issue signals representing fluid flow. The signals from sensors 1106 and 1108 could be compared with signals from 1110 in order to detect toppling of the column of the bridge.

The structures on which the sensors of the present invention could be deployed include a post configured such that it can be partially or fully embedded in the bed of material. For example, see FIG. 3.

The sensors could be deployed at various heights along structures such as bridge, including railway bridges, columns supporting structures such as bridges, culverts or river banks and the like. For example, the sensors could be deployed at different depths from the surface of the fluid such that the data from these sensors could be used, for example, for detecting the level of the fluid. Similarly, the sensors could buried in the sediment at different depths from the surface of the bed such that scour depth could be detected by analyzing measurements from various buried sensors. Information about the depths of various sensors could be encoded in the measurements emanating from the sensors such that the measurement could be used to identify the depth of the sensor. Similarly, the sensors could be designed such that the measurement from the signal also includes or encodes geographical location of each individual sensor or the system.

The sensors located above the sediment level will be free to move with the current flow and will yield dynamic flow measurements. Those sensors located below the sediment surface will be trapped and will return, for example, static measurements. Knowledge of sensor depth could be used to determine the sediment level in real time. Additional sensors located above the nominal water line may be used to determine the water level by comparing the sensor measurements to an overtopping reference sensor located high above the water line.

These sensors are designed to provide sufficient measurement points to provide useful scour measurements in real time. In contrast to the currently known scour detection methods, the systems can be deployed as an embedded array of sensors located on the outer surface of a bridge foundation. The sensors could determine the sediment depth and profile around the foundation in real time.

The systems of the present invention may include a transmission module capable of transmitting measurements from the magnetostrictive flow sensors to, e.g., a base station. The signals may include information which identifies the geographical location of individual flow sensors or of the system. Furthermore, the system may include a receiver module capable of receiving signals from, for example, the base station. The signals and measurements could be exchanged wirelessly between various modules, such as transmission module or receiver module, and base stations which form a part of the system of the present invention.

The sensor arrays of the present invention may be extended above the water line to detect incipient overtopping conditions. Incipient overtopping means that structure, such as the road or bridge, is about to be submerged in water because the stream/river level is rising to the height of the road/bridge.

Algorithms for detecting the river bed and water line, sensor fault detection algorithms, and low-cost wireless data acquisition and data processing systems are also envisioned by the present invention.

The sensor systems may be designed such that they are autonomous. An automated system can be used to monitor the locations of sensors returning static and dynamic data and maintain a map of the estimated channel bed profile. The system will also note sensors that are topographic outliers: either dynamic sensors surrounded by static sensors, or static sensors surrounded by dynamic sensors. Such sensors may indicate unusual scour, impingement of whiskers by trees or other debris, or a sensor fault condition.

An automated data acquisition base station, for example located above the water line, may be connected wirelessly to the sensors and can be used to monitor sensor measurements. The automated, embedded data processing and/or decision support system could be used which is able to perform both the basic and high-level functions of scour, river bed, and overtopping monitoring including data collection, differentiating between static and dynamic sensor readings, flow detection, estimation of channel bed depth, issuance of alerts or warnings, logging of peak scour during transient events, detection of incipient overtopping conditions, compute the profile of the riverbed at the bridge support, and monitoring of the sensing system for faulty transducers or connections.

In the present invention, the embedded data processing provides these exemplary benefits: 1) remote access; 2) reduced man hours, as scour measurements and decisions may be made automatically; 3) expedited alerts, as scour conditions can be detected in real time; and 4) drastically reduced data storage requirements, as automated processing of raw sensor data eliminate the need to store or transmit vast quantities of data to a centralized location.

The state of channel beds in scour-critical regions is always in flux. With material being continually eroded and deposited, annual measurements usually fail to capture peak events and cannot provide adequate insight into the inter-arrival periods of scour threats or their probability distributions. The automated monitoring system of the present invention can collect such data by being permanently installed and, through automated data processing, identify scour conditions that exceed a predefined threshold limit. It can also record the occurrence, severity, and duration of such events and report that information to a central database. This practice will eliminate the need to store or manually process copious raw sensor data in the final monitoring system and provide a record of transient scour conditions.

The systems of the present invention also envisions a database that is capable of storing measurements from various flow sensors. The database could be connected to the base station or to individual sensors. The database could also store data related to the fluid-bed interface. The stored data could include hydrological data, meteorological data, geological data, structural data, environmental data, and geographical data related to the interface.

In one embodiment the structure is embedded at or near the interface such that at least one magnetostrictive flow sensor is in contact with the fluid. In another embodiment the structure is deployed such that at least one magnetostrictive flow sensor is embedded in the bed.

The system of the present invention can be attached to an existing structure or to structures which are being built. The system may be deployed as a sensor post that is buried in the ground near the regions of the structure where scour is expected to occur with a base station located above water level near where the post is deployed. For monitoring scour, the base station might be on or near the structure of interest. For lateral riverbed migration it is not necessary to have any additional structures besides the sensors.

The sensor post described in the present invention includes a data logger, a wireless transmitter that will transmit a short distance to a base station, and flow sensors, such as magnetostrictive sensors that protrude from the surface of the post into the soil surrounding the post. The angle of protrusion can vary but whiskers may just protrude straight out radially from the post.

In a third aspect the present invention is related to a method of detecting and/or monitoring scour, bed migration, or overtopping associated with an interface of a fluid and a bed of material including deploying at least one first flow sensor according to present invention at or near the interface; and detecting and/or monitoring measurements from the flow sensor.

The method may also include attaching at least one second flow sensor to a structure at or near the interface such that the sensor is capable of contacting the bed. The method may also include attaching at least one third flow sensor to an object at or near the interface wherein the object is at risk of being overtopped with the fluid.

The methods according to the third aspect of the present invention could use a variety of flow sensors known in the art. These flow sensors can detect or monitor flow of a fluid. These include flow sensors such as differential pressure flow sensors, velocity flow sensors, positive displacement flow sensors, mass flow sensors, open channel flow sensors and the like. The sensors also include sensors which can detect flow based on effects such as piezoelectric effect, electromechanical effect, magnetomechanical effect or the like. In a preferred embodiment the flow sensors comprise at least one magnetostrictive sensing element.

A first flow sensor could be placed in contact with the fluid or it could be deployed such that it is buried in the sediment or is in contact with the sediment near the interface. A second flow sensor could be placed such that the sensor is in contact with the bed.

The methods of the present invention include detecting and/or monitoring scour or bed migration by comparing the measurements from a first flow sensor, which is in contact with the fluid, with the measurements from the second flow sensor, which is in contact with the bed.

The measurements from these flow sensors can be monitored in real-time as well as recorded in real time. The present invention envisions continuous monitoring of the measurements from the disclosed sensors.

A third set of flow sensors could be deployed on objects that are at or near a fluid-material interface. These objects may be at risk of being overtopped. The methods of the present invention include detecting and/or monitoring scour or bed migration or overtopping by comparing the measurement from a combination of measurements from the first flow sensor, the second flow sensor, and the third flow sensor. Furthermore, the methods include detecting and/or monitoring overtopping by comparing the signals from a combination of signals from the first flow sensor and the third flow sensor.

Depending upon the analysis of the sensor measurements, a warning or alert may be issued when there is a risk of scour and/or bed migration and/or overtopping at or near the fluid and bed interface. The warning system functions by warning the stake holders whenever there is a risk of scour or bed migration or overtopping at or near a monitored fluid and bed interface. The sensors are also capable of recording historical erosion profiles for the fluid bed interface, and providing alerts/warnings in case of dangerous situations.

The methods include recording scour levels that, e.g., exceed the owner's level of concern. The systems according to the present invention can issue high-scour alerts that indicate significant scour conditions that may result in damage to, for example, a bridge, or even a collapse of the bridge. These alerts can be bridge specific (based on the bridge design, usage, and susceptibility to scour) and be designed, based on a set of conditions determined by the bridge owner, as representing an unacceptable risk to the public. The trigger conditions could include, for example, scour below the bottom of the footing for spread footing bridges, scour within 10 feet or less of a pile tip for pile supported piers, or a percentage of the pier that is exposed. Once the trigger condition is met, the system will be able to issue an alert to authorities and recommend bridge closure and immediate manual inspection. For heavily trafficked bridges, the system could also close the bridge itself via traffic signals or even crossing gates. Additional magnetostrictive flow sensors placed above the nominal waterline (in close proximity to the bridge deck) can provide an alert when high water conditions become critical.

In a fourth aspect the present invention is related to using the sensors of the present invention for detection of other physical phenomena, including force, acoustic pressure, tactile/haptic/navigation applications, applications where biological systems employ whisker sensors, active whiskers, for instance to create turbulence in flows to improve ability of these or other sensors to detect low concentrations of chemical or biological species, or low flow rates, detection of vibrations.

The sensor can be designed for use in sensing, for example, fluid flow, force, displacement, vibration, frequency of vibrations, fluid flow rates. The magnetostrictive sensing elements can be designed such that they can deform in a flowing fluid or exhibit strain upon contacting a flowing fluid. In a preferred embodiment, the sensors have a magnetostrictive sensing element.

Combinations of the systems and methodology described by the present invention can be employed by a person to effectively and safely manage bridges and other hydrologic structures. Real-time data can be rapidly collected, processed, and logically presented with the prior and historical data, so that a response may be orchestrated in a timely and cost-effective manner. Corrective measures may include physical inspection, closing of bridges to traffic, and/or repair or replacement of the structures in question.

Data collection, presentation, and timely user notification of problems are particularly important for successful monitoring of scour critical structures and other structures whose performance can be affected by meteorological and hydrological conditions.

The systems and methods of the present invention provide a means of extracting and processing real-time data from sensors attached to bridges and related structures and the local environment. The data can be collected and relayed via a communications network to a central site. The historical and analytical information concerning the structures are stored in a database and presented at the central site in a coordinated manner with the real-time data. Thresholds can be established in any relevant parameter and when any such threshold is reached, the system may present a prioritized notice at the central site and notify appropriate users of the system via relevant communication hardware such as, phones, cell phones, facsimiles, pagers, PDAs (personal digital assistants) and instant messaging.

The system of the present invention could also be connected to a communications network that may be the Internet, a local network with a portal to the Internet, or groups of networks and redundant computer systems and/or networks.

### EXAMPLES

### Example 1

### Testing of the Sensor

To test the feasibility of the sensor, a series of laboratory experiments may be conducted. A cylindrical pier of 0.15 m (0.5 ft) can be mounted in the test section of FIG. 6. Flow can be set to the “clear-water” condition, meaning that the velocity of the water will be approximately 95% of the velocity that results in bed sediment movement in an area outside the influence of the local scour induced by the pier. Measurements of the water and bed surface at a location upstream of the pier (area of deepest scour) can be continuously monitored throughout the tests to determine the detectability of both water and sediment surfaces by the proposed sensors. At the initiation of the experimental run the sediment bed will be level and, therefore, some of the proposed sensors will be buried under the sediment. As the scour progresses, however, the bed sediment will scour below these initially-buried sensors and thereby expose them. In addition, the pump flow rate can be altered which will cause a concomitant change in water level. This approach will allow a determination of scour detectability, water surface detectability, and optimize the length of the magnetostrictive scour sensing elements for disclosed applications.

The term near a fluid-bed interface as used in the present invention is meant to describe a range of 1000 feet to 0.01 inch. In one embodiment the range could be 900 feet to 0.01 inch. In another embodiment the range could be 800 feet to 0.01 inch. In yet another embodiment the range could be 700 feet to 0.01 inch. In yet another embodiment the range could be 600 feet to 0.01 inch. In yet another embodiment the range could be 500 feet to 0.01 inch. In yet another embodiment the range could be 400 feet to 0.01 inch. In yet another embodiment the range could be 300 feet to 0.01 inch. In yet another embodiment the range could be 200 feet to 0.01 inch. In yet another embodiment the range could be 100 feet to 0.01 inch. In yet another embodiment the range could be 90 feet to 0.01 inch. In yet another embodiment the range could be 80 feet to 0.01 inch. In yet another embodiment the range could be 70 feet to 0.01 inch. In yet another embodiment the range could be 60 feet to 0.01 inch. In yet another embodiment the range could be 50 feet to 0.01 inch. In yet another embodiment the range could be 40 feet to 0.01 inch. In yet another embodiment the range could be 30 feet to 0.01 inch. In yet another embodiment the range could be 20 feet to 1 inch. In yet another embodiment the range could be 10 feet to 1 inch. In yet another embodiment the range could be 5 feet to 1 inch.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A sensor comprising at least one magnetostrictive sensing element.

2. The sensor according to claim 1, wherein the magnetostrictive sensing element has at least one free floating distal end.

3. The sensor according to claim 1 further comprising a reader coupled to the magnetostrictive sensing element wherein the reader can operably detect and/or monitor deformation of the magnetostrictive sensing element.

4. The sensor according to claim 2 wherein the free floating distal end is capable of sensing a flowing fluid.

5. The sensor of claim 1 adapted to be introduced into a fluid.

6. The sensor of claim 1 adapted to be introduced on, in, or under a bed of material.

7. The sensor of claim 1 further comprising a transmission module capable of transmitting measurements from the sensor.

8. The sensor of claim 1 wherein the magnetostrictive sensing element is in the shape of a cantilever arm.

9. The sensor of claim 1 wherein the magnetostrictive sensing element is substantially covered with a coating.

10. The sensor of claim 9, wherein the coating is epoxy, chromium electroplating, tin, a plastic coating, galvanizing coating, or a combination thereof.

11. The sensor of claim 1, wherein the magnetostrictive sensing element comprises Galfenol, Terfenol-D, Alfenol, Metglas, iron, nickel, cobalt, iron aluminium alloy, iron cobalt, or a combination thereof.

12. The sensor of claim 1, wherein the sensor further comprises a housing adapted to be introduced in a fluid.

13. A system for detecting and/or monitoring scour, bed migration, or overtopping associated with an interface between a fluid and bed of material comprising:
at least one first flow sensor disposed at or near the interface such that the sensor is capable of detecting and/or monitoring scour, bed migration, or overtopping.

14. The system of claim 13 wherein the flow sensor comprises a magnetostrictive sensing element.

15. The system of claim 13 further comprising a structure wherein a part of the structure is capable of contacting the bed of material.

16. The system of claim 15, wherein the structure is in the shape of a post configured such that it can be partially or fully embedded in the bed of material.

17. The system of claim 15, wherein the structure is a part of a bridge, a river bank, a river bed, a pier, or culvert.

18. The system of claim 15 further comprising at least one second flow sensor disposed on the part of the structure such that the sensor is capable of contacting the bed.

19. The system of claim 18 wherein the second flow sensor comprises a magnetostrictive sensing element.

20. The system of claim 13 further comprising at least one third flow sensor disposed on an object at or near the interface wherein the object is at risk of being overtopped with the fluid.

21. The system of claim 20 wherein the third flow sensor comprises a magnetostrictive sensing element.

22. The system of claim 13 further comprising a transmission module capable of transmitting measurements from the flow sensor to a base station.

23. The system of claim 22 wherein the transmission module identifies geographical location of individual flow sensors or of the system.

24. The system of claim 22 further comprising a receiver module capable of receiving signals from the base station.

25. The system of claim 22, wherein the base station can exchange information with a database.

26. The system of claim 22, wherein the measurements are transmitted wirelessly.

27. The system of claim 24, wherein the signals are wireless.

28. The system of claim 13, wherein a plurality of first flow sensors are disposed such that the sensors are located at different depths from the surface of the fluid.

29. The system of claim 13, wherein a plurality of first flow sensors are disposed such that the sensors are located at different depths from the surface of the bed.

30. The system of claim 18, wherein a plurality of second flow sensors are disposed on the part such that the sensors are located at different depths from the surface of the bed.

31. The system of claim 25 wherein the database is capable of storing measurements from the flow sensors.

32. The system of claim 25 wherein the database comprises stored data related to the interface.

33. The system of claim 32 wherein the stored data related to the interface comprises at least one of hydrological data, meteorological data, geological data, structural data, environmental data, and geographical data.

34. A method of detecting and/or monitoring scour, bed migration, or overtopping associated with an interface of a fluid and a bed of material comprising:
deploying at least one first flow sensor at or near the interface; and
detecting and/or monitoring measurements from the flow sensor.

35. The method according to claim 34, wherein the flow sensor comprises a magnetostrictive sensing element.

36. The method of claim 34 further comprising attaching at least one second flow sensor to a structure at or near the interface such that the second flow sensor is capable of contacting the bed.

37. The method of claim 34, further comprising attaching at least one third flow sensor to an object at or near the interface wherein the object is at risk of being overtopped with the fluid.

38. The method of claim 34, wherein at least one first flow sensor is in contact with the fluid.

39. The method according to claim 34, wherein at least one first flow sensor is in contact with the bed.

40. The method according to claim 31, wherein the step of detecting and/or monitoring the measurements occurs in real-time.

41. The method according to claim 36, wherein the step of detecting and/or monitoring further comprises comparing the measurements from the first flow sensor with the measurements from the second flow sensor.

42. The method according to claim 37, wherein the step of detecting and/or monitoring further comprises comparing the measurements from a combination of measurements from the first flow sensor, the second flow sensor, and the third flow sensor.

43. The method according to claim 31, further comprising issuing an alert when there is a risk of scour and/or bed migration and/or overtopping.

44. The method according to claim 31, further comprising recording the measurements from the flow sensors.

45. A method of using a sensor for detecting fluid flow, force, displacement, vibration, frequency of vibrations, and/or fluid flow rates.

46. The method according to claim 45, wherein the sensor comprises a magnetostrictive element.
